(19) United States
(12) Patent Application Publication
(10) Pub. No.: US 2009/0089173 A1
(43) Pub. Date: Apr. 2, 2009

(54) Retail price output system

(76) Inventor: Keishi Miyake, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 11/918,523

(22) PCT Filed: Dec. 22, 2005
(86) PCT No.: PCT/JP2005/023648

§ 371 Date: Oct. 15, 2007

(30) Foreign Application Priority Data
Apr. 18, 2005 (JP) 2005-119511
Sep. 26, 2005 (JP) 2005-277145
Nov. 30, 2005 (JP) 2005-345339

(51) Int. Cl. G06Q 30/00; G06Q 20/00

(52) U.S. Cl. 705/20

(57) ABSTRACT

The present invention intends to provide a system for determining prices so that the price of a poor-selling product is decreased, and the price of a well-selling product is increased, so as to ensure profit and achieve more effective inventory management. The retail price output system of the present invention comprises setting means in which a reference price of a product is set, recognition means for recognizing an order quantity from a customer for a product, pricing means for increasing or decreasing the list price of the product with respect to the reference price according to the order quantity for the product and an inventory quantity of the product, and price outputting means for outputting data for list price determined by the pricing means to a customer computer, wherein the list price of the product may be increased with respect to the reference price.

### TECHNICAL FIELD

The present invention relates to a retail price output system for automatically making and outputting a retail price according to various fluctuating market forces after receipt of a market order via a network, in which a retail price relevant to the order is made automatically according to various fluctuating market forces or selling power.

### RELATED BACKGROUND ART

There are well-known or used retailing systems that are configured to sell a product at a retail price according to the fluctuating market conditions or forces after receipt of a market order via a network. In these regards, there are two types of retailing systems, one of which keeps a constant retail price regardless of the ordered quantity, the other undercutting its retail price with a higher reduction rate according to an increase in the ordered quantity, that is, the product relevant to the ordered quantity is sold at a lower price.

### DISCLOSURE OF THE INVENTION

However, in such a conventional pricing system as the one described above, inventory management problems occur in that poor-selling products are always left unsold, and the inventory of well-selling products is depleted rapidly. Since well-selling products may also continue to sell at a slightly higher price, potential profits may also be lost.

Therefore, an object of the present invention is to provide a system for determining prices so that the price of a poor-selling product is decreased, and the price of a well-selling product is increased, so as to ensure profit and achieve more effective inventory management.

The retail price output system according to a first aspect of the present invention is a retail price output system configured so as to be capable of connecting to a plurality of customer computers via a network and determining a list price according to an order quantity from said customers and outputting the determined list price via said network to said customers, said retail price output system characterized by comprising of setting means for setting a reference price of a product; recognition means for recognizing an order quantity from a customer for a product; pricing means for increasing or decreasing the list price of the product from said reference price according to said order quantity for the product and an inventory quantity of the product; and price outputting means for outputting data for list price determined by said pricing means to a customer.

The term “customer” includes a person who is actually ordering a product, and a person who attempts to confirm a price with intent to purchase.

A configuration can be adopted in which the order quantity from a customer for a product is entered in the customer computer, and recognized by the recognition means via the network.

A second aspect of the present invention is characterized in that the pricing means increases the list price of the product when said order quantity exceeds a reference order quantity.

A third aspect of the present invention is characterized in that the pricing means increases the list price of the product when the inventory quantity of the product is reduced under a reference inventory quantity.

According to a fourth aspect of the present invention, the setting means is configured so as to update and set the list price determined in said pricing means as a reference price for the following order in said setting means.

According to a fifth aspect of the present invention, the pricing means is configured so as to update and set the reference price each time, an order is determined a date changes, a prescribed day of the week occurs; a prescribed time occurs or an inventory quantity is outside a prescribed quantity range.

According to a sixth aspect of the present invention, the recognition means is configured so as to recognize an order quantity via the network when an order quantity from a customer for a product is entered through a computer at its customer side.

According to a seventh aspect of the present invention, the recognition means is configured so as to recognize an order quantity when an order quantity from a customer for a product is obtained by any of a mailing that includes an order form filled out by the customer, an order sheet electronically transmitted by fax, or order information that is received by telephone.

According to an eighth aspect of the present invention, at least one of a maximum price and a minimum price for the list price of a product in the pricing means is determined in advance for each product.

According to ninth and tenth aspects of the present invention, a notification means is furthermore provided for notifying the customer when the determined data for list price or the inventory quantity is higher or lower than a price that is set in advance by the customer.

According to eleventh and twelfth aspects of the present invention, an automatic ordering means is furthermore provided for automatically performing an ordering procedure when the determined data for list price or the inventory quantity satisfies a condition that is set in advance by the customer.

According to a thirteenth aspect of the present invention, an automatic setting means is furthermore provided for automatically determining an update interval for the reference inventory quantity or the reference price and setting the update interval in the system when an arbitrarily set price is entered for each product.

According to a fourteenth aspect of the present invention, the automatic setting means is furthermore configured so as to automatically determine an update interval for the reference price and set the update interval in the system when an arbitrarily set reference inventory quantity is entered for each of the products.

According to a fifteenth aspect of the present invention, the product includes at least one of a tangible product, provision of information or an intangible service, and a transfer or loan of property.

The customer computer according to a sixteenth aspect of the present invention is characterized by comprising display means for displaying data for list price that are determined by the pricing means, wherein the display means provides a display to the effect that the determined data for list price have increased, decreased, or remained unchanged with respect to the reference price prior to updating.

### EFFECT OF THE INVENTION

According to the present invention, since a pricing means is provided for increasing or decreasing the list price of a product with respect to the reference price according to the inventory quantity of the product and the order quantity for the product, proper inventory management and a proper sales margin can be maintained.

Since the list price of a product is increased when the order quantity is greater than the reference order quantity, adequate profit can be maintained for a well-selling product.

The list price determined by the pricing means is also updated and set in the setting means as the reference price for the following order, and the reference price therefore differs according to past order conditions, and the list price is also not necessarily the same even when the order quantity is the same.

### BRIEF DESCRIPTION OF THE DRAWINGS

FIG. 1 is a schematic diagram showing the structure of an embodiment of the retail price output system according to the present invention;

FIG. 2 is a flowchart showing the pricing procedure in the retail price output system; and

FIG. 3 is a diagram showing the fluctuation and the like of the list price in the case of the example.

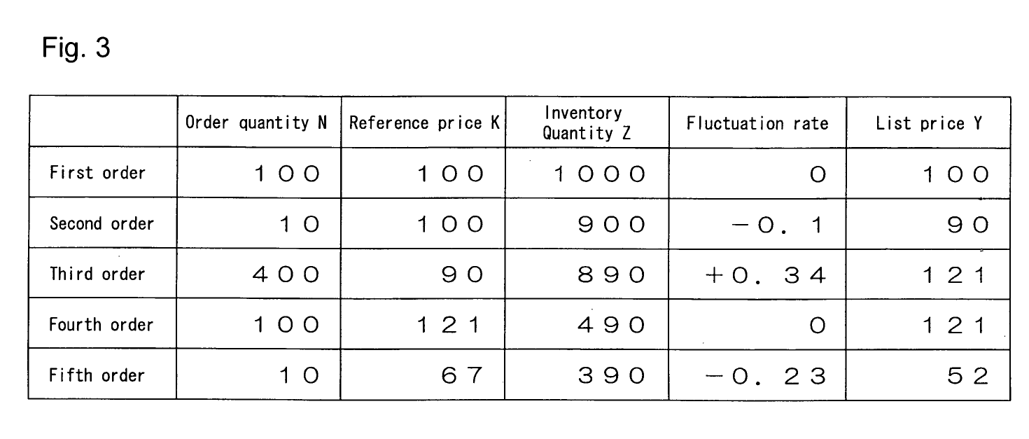

### DESCRIPTION OF PREFERRED EMBODIMENTS

The retail price output system according to the present invention will be described in detail hereinafter based on drawings that show embodiments of the present invention.

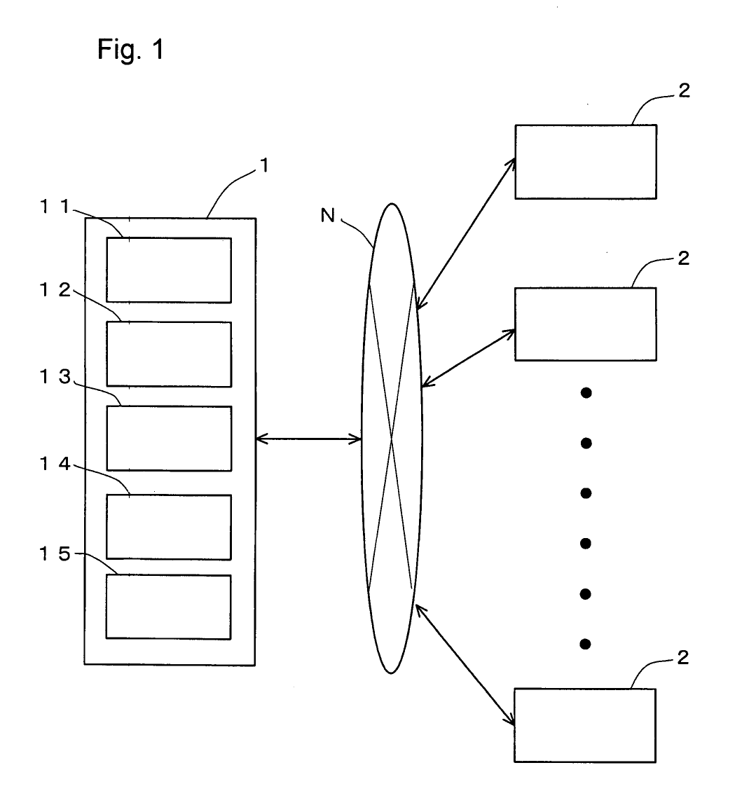

In FIG. 1, the reference numeral 1 indicates a server composed of vendor computers in which the retail price output system of the present invention is incorporated, and 2 indicates customer computers that are configured so as to be capable of connecting to the server 1 via the Internet or another network N.

The retail price output system that is incorporated into the server 1 is provided with setting means 11 in which a reference price of a product is set for each of various products that are handled; recognition means 12 for receiving and recognizing an order quantity transmitted from a customer computer 2 for a product via the network N; pricing means 13 for increasing or decreasing the list price of the product with respect to the reference price according to the order quantity for the product and an inventory quantity of the product; and price outputting means 14 for outputting data for list price determined by the pricing means to a customer computer 2 via the network N.

The customer computers 2 are configured so as to be capable of transmitting an order quantity via the network N to the retail price output system that is incorporated into the server 1, via Internet Explorer (registered trademark of Microsoft Corporation) or other browser software, and receive the retail price that is outputted from the retail price output system via the network N and display the retail price on a screen or the like.

A function for recognizing the retail price and transmitting order data to the server 1 is furthermore provided.

In the retail price output system that is incorporated into the server 1, the function shown below is incorporated as a list pricing means for each product:

Y=f(N,Z,K)

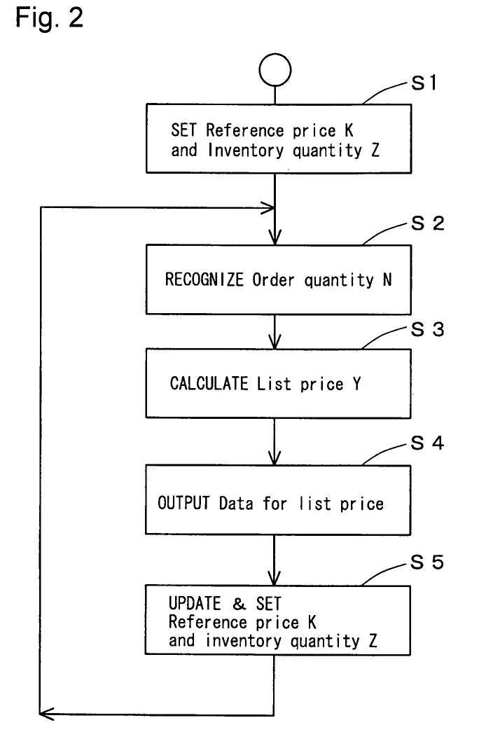

(where N is the order quantity, Z is the inventory quantity, K is the reference price, and Y is the list price). The overall operation of the retail price output system is shown in the flowchart in FIG. 2.

The inventory quantity Z is automatically updated by inventory quantity updating means 15 for each product each time an order is determined, or each time a date changes.

The setting means 11 is configured so as to substitute the reference price K of each product with the retail price determined by the pricing means 13, and update and set the reference price K of each product each time an order is determined or each time the date changes.

According to the configuration described above, a high price can be determined for the list price of a well-selling product for which there is a large number of orders, and large profits can be ensured. A rapid elimination of inventory can also be prevented. Since a low price can also be determined for a poor-selling product for which there is a small number of orders, the product is easily sold and inventory can be prevented from increasing.

The abovementioned network N includes WAN, LAN, and other networks, and includes list price output functionality that utilizes a television device connected to a two-way communication system having television broadcast functionality, a mobile telephone connected to a broadcast system (1SEG or the like) having two-way communication functionality for mobile telephones, a storefront terminal device connected to various networks; and that further utilizes mobile telephones, PDAs, and the like.

The order quantity from the customer for a product may be recognized by using recognition means that uses a scanner, a voice recognition means, a keyboard operated by an operator, or the like to recognize order information that is conveyed by a WAN, LAN, or other network; a television device that is connected to a two-way communication system having television broadcast functionality; a mobile telephone that is connected to a broadcast system (1SEG or the like) having two-way communication functionality for mobile telephones; a storefront terminal device that is connected to various networks; a mobile telephone; a PDA; an order postcard or other mail article filled out by the customer; an order using a home delivery agency; an order sheet electronically transmitted by fax; or a telephone.

The product is also not limited tq a tangible product, and includes at least one of leasing; the provision of a massage, health care intervention, and other intangible services; provision of various types of information such as news, weather forecasting, or inventory information; provision of software, music, images, and other data download services; provision of lodging, provision of concert and other tickets and the like; provision of currency certificate exchanges; transfer or lending of real estate; transfer, loan, or sale of pets and other animals; and the like.

### Example 1

A case will be described in Example 1 in which a function such as Y=f (N, Z, K) is incorporated into the list pricing means for a certain product, wherein N is the order quantity, Z is the inventory quantity, K is the reference price, R is a fluctuation rate, and Y is the list price.

R=(N−100)/Z

Y=K(1+R)

A state is described in this example in which the reference price K=100 Yen, and the inventory quantity Z=1000.

The reference inventory quantity is 100 in this case. Consequently, a price increase occurs when the order quantity exceeds 100, and a discount occurs when the order quantity is less than 100. Values are appropriately rounded in computational processing.

In a first order, when an order quantity of 100 (N=100) is transmitted from a certain customer computer 2 for the product, the computations R=(100−100)/1000=0, and list price Y=100×(1+0)=100 are performed in the server 1, and 100-Yen data for list price are transmitted. Accordingly, order information that includes the unit price of 100 Yen and a total amount of 10000 Yen is displayed for the order quantity of 100 in the screen of the customer computer 2. When this information is acknowledged, and an order is issued, order data are transmitted from the customer computer 2 to the server 1, and order processing and product shipping processing are performed in the server 1. The inventory quantity is then updated to 900.

In a second order, when an order quantity of 10 (N=10) for the product is transmitted from a certain customer computer 2 (the same customer or a different customer), the computations R=(10−100)/900=−0.1 (i.e., a 10% discount), and list price Y=100×(1−0.1)=90 are performed in the server 1, and 90-Yen data for list price are transmitted. Accordingly, order information that includes the unit price of 90 Yen and a total amount of 900 Yen is displayed for the order quantity of 10 in the screen of the customer computer 2. When this information is acknowledged, and an order is issued, order data are transmitted from the customer computer 2 to the server 1, and order processing and product shipping processing are performed in the server 1. The inventory quantity is then updated to 890.

At this time, the reference price in the setting means is updated from 100 Yen to 90 Yen and set. In the second order, since the order quantity is smaller than in the first order, a lower price is determined for the list price.

Then, in a third order, when an order quantity of 400 (N=400) for the product is transmitted from a certain customer computer 2 (the same customer or a different customer), the computations R=(400−100)/890=+0.34 (i.e., a price increase of approximately 34%), and list price Y=90×(1+0.34)=121 are performed in the server 1, and 121-Yen data for list price are transmitted. Accordingly, order information that includes the unit price of 121 Yen and a total amount of 48400 Yen is displayed for the order quantity of 400 in the screen of the customer computer 2. When this information is acknowledged, and an order is issued, order data are transmitted from the customer computer 2 to the server 1, and order processing and product shipping processing are performed in the server 1. The inventory quantity is then updated to 490.

At this time, the reference price in the setting means is updated from 100 Yen to 121 Yen and set. In the third order, since the order quantity is larger than in the first order, a higher price is determined for the list price.

In a fourth order, when an order quantity of 100 (N=100) for the product is transmitted from a certain customer computer 2 (the same customer or a different customer), the computations R=(100−100)/890=0, and list price Y=121×(1+0)=121 are performed in the server 1, and 121-Yen data for list price are transmitted. Accordingly, order information that includes the unit price of 121 Yen and a total amount of 12100 Yen is displayed for the order quantity of 100 in the screen of the customer computer 2. When this information is acknowledged, and an order is issued, order data are transmitted from the customer computer 2 to the server 1, and order processing and product shipping processing are performed in the server 1. The inventory quantity is then updated to 390. In the fourth order, the order quantity is the same as in the first order, but the inventory quantity is reduced, and a higher price is therefore determined for the list price.

In a case in which there are no orders the following day, the computations R=(0−100)/390=−0.26 (i.e., a discount of approximately 26%), and list price Y=121×(1−0.26)=90 are performed in the server 1, and the reference price is updated and set to 90 Yen.

When there are again no orders the following day, the computations R=(0−100)/390=−0.26 (i.e., a discount of approximately 26%), and list price Y=90×(1−0.26)=67 are performed in the server 1, and the reference price is updated and set to 67 Yen.

Consequently, in a fifth order, when an order quantity of 10 (N=10) for the product is transmitted from a certain customer computer 2 (the same customer or a different customer), the computations R=(10−100)/390=−0.23 (i.e., a discount of approximately 23%), and list price Y=67×(1−0.23)=52 are performed in the server 1, and 52-Yen data for list price are transmitted. Accordingly, order information that includes the unit price of 52 Yen and a total amount of 520 Yen is displayed for the order quantity of 10 in the screen of the customer computer 2. When this information is acknowledged, and an order is issued, order data are transmitted from the customer computer 2 to the server 1, and order processing and product shipping processing are performed in the server 1. The inventory quantity is then updated to 380.

In the fifth order, the order quantity is the same as in the first order, but since the fifth order took place after a succession of no-sale days, a lower list price was determined regardless of the reduction in the inventory quantity.

According to this configuration, even when the order quantity is the same, the presented list price fluctuates as shown in FIG. 1 according to the current inventory quantity. When the order quantity is small, the reference price is gradually reduced, whereby the list price is fixed, the willingness to buy is stimulated, and sales are accelerated. The list price is also set high in order to secure adequate profit when the order quantity is large.

A maximum price and a minimum price are preferably set in advance to desired amounts for each product without regard for inventory quantity and order quantity.

Since the list price is gradually reduced in this manner, effects are obtained whereby the inventory is easily reduced even for products for which the inventory tends to remain high using conventional retailing methods.

The inventory quantity Z was updated each time an order was determined, but the inventory quantity Z may also be updated and set each time the date changes. The interval for updating the reference price may be changed according to the inventory quantity. For example, the updating interval may be shortened when the inventory quantity is lower than a reference value.

The reference price K in the setting means 11 was updated each time an order was determined, but the reference price K may also be updated and set each time the date changes, or may be updated and set at an arbitrarily set day of the week, day, time, or the like.

In the example described above, the function Y=f (N, Z, K) was incorporated as the list pricing means for each product in the retail price output system that was incorporated into the server 1, but a list pricing means that uses a reference table may also be used.

In another implementation of the system described above, means may be provided for notifying the customer via electronic mail or other communication means when the price rises above or falls below a price set in advance by the customer for a product that is set in advance by the customer.

Automatic ordering means may also be provided that is capable of automatically performing the ordering procedure to make an automatic purchase when a price set in advance by the customer is achieved for a product for which the price has been set in advance by the customer. Furthermore, various auxiliary systems may also be incorporated to reduce the labor required for registering each product in the system of the present invention.

For example, automatic setting means may be provided for automatically determining the reference inventory quantity or the update interval for a reference price, and setting the reference inventory quantity or the update interval for the reference price in the system by entering an arbitrarily set price for each product.

The automatic setting means may also be configured so as to automatically determine the update interval for the reference price and to set the update interval for the reference price in the system by entering a reference inventory quantity that is arbitrarily set for each product.

1. A retail price output system configured so as to be capable of connecting to a plurality of customer computers via a network and determining a list price according to an order quantity from said customers and outputting the determined list price via said network to said customers, said retail price output system characterized by comprising of:
setting means for setting a reference price of a product;
recognition means for recognizing an order quantity from a customer for a product;
pricing means for increasing or decreasing the list price of the product from said reference price according to said order quantity for the product and an inventory quantity of the product; and
price outputting means for outputting data for list price determined by said pricing means to a customer.

2. The retail price output system according to claim 1, characterized in that said pricing means increases the list price of the product when said order quantity exceeds a reference order quantity.

3. The retail price output system according to claim 1, characterized in that said pricing means increases the list price of the product when the inventory quantity of the product is reduced under a reference inventory quantity.

4. The retail price output system according to claim 1, characterized in that said setting means is configured so as to update and set the list price determined in said pricing means as a reference price for the following order in said setting means.

5. The retail price output system according to claim 1, characterized in that said pricing means is configured so as to update and set the reference price each time
an order is determined;
a date changes;
a prescribed day of the week occurs;
a prescribed time occurs; or
an inventory quantity is outside a prescribed quantity range.

6. The retail price output system according to claim 1, characterized in that said recognition means is configured so as to recognize an order quantity via the network when an order quantity from a customer for a product is entered through a computer at that customer side.

7. The retail price output system according to claim 1, characterized in that said recognition means is configured so as to recognize an order quantity when an order quantity from a customer for a product is obtained by any of a mailing that includes an order form filled out by the customer, an order sheet electronically transmitted by fax, or order information that is received by telephone.

8. The retail price output system according to claim 1, characterized in that at least one of a maximum price and a minimum price for the list price of a product in said pricing means is determined in advance for each product.

9. The retail price output system according to claim 1, comprising notification means for notifying said customer when said determined data for list price is higher or lower than a price that is set in advance by said customer.

10. The retail price output system according to claim 1, comprising notification means for notifying said customer when said inventory quantity is higher or lower than a quantity that is set in advance by said customer.

11. The retail price output system according to claim 1, comprising automatic ordering means for automatically performing an ordering procedure when said determined data for list price satisfy a condition that is set in advance by said customer.

12. The retail price output system according to claim 1, comprising automatic ordering means for automatically performing an ordering procedure when said inventory quantity satisfies a condition that is set in advance by said customer.

13. The retail price output system according to claim 1, characterized in comprising automatic setting means for automatically determining an update interval for the reference inventory quantity or the reference price and setting the update interval in the system when an arbitrarily set price is entered for each product.

14. The retail price output system according to claim 1, characterized in that said automatic setting means is furthermore configured so as to automatically determine an update interval for the reference price and set the update interval in the system when an arbitrarily set reference inventory quantity is entered for each of said products.

15. The retail price output system according to claim 1, characterized in that said product includes at least one of a tangible product, provision of information or an intangible service, and a transfer or loan of property.

16. A customer computer capable of connecting to the retail price output system according to claim 1, said customer computer characterized in comprising:
display means for displaying data for list price that are determined by said pricing means; wherein
said display means provides a display to the effect that said determined data for list price have increased, decreased, or remained unchanged with respect to the reference price prior to updating.
